(19) United States
(12) Patent Application Publication
(10) Pub. No.: US 2008/0064773 A1
(43) Pub. Date: Mar. 13, 2008

(54) AERATED GLUTEN POLYMERIC COMPOSITION

(75) Inventors: Mark Levin, Papillion, NE (US); Li Nie, Parkville, MO (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: SERGEANT'S PET CARE PRODUCTS INC., Omaha, NE (US)

(21) Appl. No.: 11/686,776

(22) Filed: Mar. 15, 2007

Related U.S. Application Data
(63) Continuation-in-part of application No. 10/443,631, filed on May 22, 2003, now abandoned.

(51) Int. Cl. C08J 9/28

(52) U.S. Cl. 521/72

(57) ABSTRACT

The present invention relates to methods for producing an aerated polymeric composition or aerated polymeric pet chew and the resultant product. The aerated pet chew includes a dry blend, a leavening agent, and a plasticizing slurry. The dry blend includes an amount of protein polymer.

### CROSS-REFERENCE TO RELATED APPLICATION

This application is a continuation-in-part of Ser. No. 10/443,631 filed on May 22, 2003, which is hereby incorporated by reference in its entirety.

### FIELD OF THE INVENTION

The present invention is directed to an aerated polymeric composition, with the composition formed from a protein polymer and a leavening agent, or method, for causing porosity, or aeration, in the finished aerated polymeric composition. Additionally, the present invention relates to methods for forming the aerated polymeric composition. The aerated polymeric composition may be used as a pet chew or as a biodegradable packing material.

### BACKGROUND OF THE INVENTION

People have kept pets, such as dogs, since the beginnings of recorded history. Presently, dogs are popular pets worldwide. Related to this, dog and cat owners are becoming increasingly concerned about the health and hygiene of their animals at all stages of the animals' lives. Maintenance of dental health and hygiene for dogs and cats has become a prime concern of pet owners and is typically achieved through providing the pet with chewable pet toys or other chewable articles. Chewable articles include long term products, which can be chewed for a couple of days, and short term products, which can be consumed in less than five minutes. As such, pet chews, especially for dogs and cats, are common products provided to pets.

Like people, as dogs and cats get older, their teeth become loose. Standard and known chews, which are hard and lack pliability, are not well suited for older pets. As such, it is desired to have a chew directed towards older pets and pets that are not typical chewers (smaller in stature dogs and most cats). A suitable chew will have a ductile texture that exhibits good tensile strength, is soft, more pliable than most known chews, and has an aerated construction to aid in delivering a texture more suitable for dogs and cats who are not typical chewers, who are too young to chew larger, tougher chews, or are old and not capable of chewing the tough chews.

The chews should be of a formulation that can be flavored so as to appeal to most pets' taste preferences. Optionally, the chews can provide nutritional or health benefits. It is desired to have a pet chew composition that can be flavored in a variety of ways, and which can be readily digested. It is especially desired to have a chew made primarily from protein so as to provide a pet with some nutritional benefits instead of just a filler.

Known chews have been formed from a variety of polymers. Suitable known polymeric compositions for use in forming a chew include synthetic polymers made from petrochemicals, natural polymers such as starch and protein, and combinations of these materials. In particular, polymers made from wheat gluten and starch, and other related polymers, have been used to produce pet chews. These chews can be ductile, but very firm, and require long periods of mastication to break down. Often these chews require more energy than an older dog, or a dog that is not a typical chewer, can supply. Despite the difficulties of using a plant protein to form a chew, such composition is desired because it is readily digested, is considered a “natural” material, and delivers a unique ductile texture. Because of these characteristics, it is desired to have a chew made from vegetable proteins, such as the wheat gluten polymer, but the chew should have a different texture than known chews. It is especially desired to have a chew formed from wheat gluten that is pliable and has an aerated construction.

Plant protein polymers have been known for use in a variety of compositions. In particular, it has been known to use wheat gluten and related plant protein compositions to form a variety of chews and treats, as identified in U.S. Pat. No. 5,665,152. In particular, these chew products include a protein polymer, a starch, a plasticizer, and a reducing agent, such as sodium bisulfite or metabisulfite. The required reducing agent is added to donate an electron to the protein making the chew composition flowable and processable through an injection or extrusion molding process. These known chew products tend to be of a dense nature and can be difficult to masticate. It is desired to have a method related to the protein polymer product formulation, which produces an aerated product that is ductile and compressible without the addition of a reducing agent. It is especially desired to have an aerated protein polymer product.

Furthermore, soft chews that can be readily flavored are not readily available; however, it is believed that such chews are desired by consumers. It is especially desired to have a soft and pliable chew formed from protein and not carbohydrates.

Dental bones are products for pets that are related to chews. Essentially, dental bones are thicker, harder versions of the chews. Most known dental bones exhibit drawbacks in that they are hard and brittle, or are extremely tough. Also, when allowed to become wet, over time the bones become easily misshaped and unsightly when compared to their original configurations. Also, as the bones are chewed, small pieces can break off and can become a choking hazard to a dog or other pet. Moreover, many of these dental bones are not suitable for older dogs. As such, it is desired to have a dental bone product that does not chip or break into small pieces and has an acceptable texture for those pets who need a safer and more gentle chew. The chew, preferably, is ductile enough to rub the pet's teeth and form around teeth to yield a rubbing action around the whole tooth. It is further desirable to have this ductile product contain inclusions, which will improve the cleaning properties of the chew by scraping the tooth.

It can be desired to use a plant protein that has had starch substantially removed. As such, compositions formed from plant proteins that have been separated of starch are preferred.

As such, it is desired to have an aerated pet chew that has a ductile texture and exhibits good tensile strength. It is further desired to have a product formed from a plant polymer, especially a wheat gluten polymer. Finally, it is desired to have a method available for forming a pet chew made from known polymeric materials.

### SUMMARY OF THE INVENTION

The present invention relates to an aerated polymeric composition, which exhibits unique textural and functional properties. In particular, the present invention relates to an aerated polymeric composition containing plant protein and methods for making the composition. Additionally, the present invention relates to methods for producing the aerated polymeric composition. The resultant aerated polymeric composition is well suited for use as a unique pet chew for geriatric pets and those pets less prone to chew. As would be guessed, additional uses for the resultant material are also contemplated, such as a biodegradable packing material.

The method for producing the aerated polymeric material starts with a protein polymer material. Any of a variety of protein sourced polymers may be used. The polymers include plant and animal derived protein polymers; however, it is most preferred to use a plant derived protein polymer that has had the starch substantially removed. Preferably, there is less than 10% by weight of starch in the protein. More particularly, it is desired to use an amount of wheat gluten, or a similar plant polymer. Thus, it is desired to use processed wheat gluten that has had substantially all starch removed. The aerated polymeric composition is formed when the polymeric composition is aerated. The polymeric composition is formed from a dry blend and a plasticizing slurry. The dry blend is formed from the protein polymer and additives. The plasticizing slurry is formed from liquid constituents, which hydrate and plasticize the dry blend.

A variety of additives or constituents may be mixed with the protein polymer to form the dry blend. Such additives include animal sourced proteins, processing aids, flavors, starch, cellulose, and colors. Magnesium stearate can be added to the dry blend as a processing aid to reduce stickiness and act as a release agent in the forming step of the process. The addition and amount of such constituents are dependent upon the desired final product.

An amount of leavening agent is added to the dry blend or polymeric composition. The leavening agent is added to cause the formation of a polymer having an aerated construction and a lower density. Generally, a variety of leavening agents or methods can be used to aerate the polymeric material, including physical addition of chemical leavening agents, compressed gasses, or microbiologic fermentation. Preferred leavening agents include a chemical leavening agent and compressed gas. The most preferred leavening agent includes chemical additives such as sodium bicarbonate or sodium bicarbonate in combination with sodium acid pyrophosphate, ammonium phosphate, monocalcium phosphate, sodium aluminum phosphate, and any other related compositions that create a release of gasses. The chemical leavening agent will be added in an amount ranging between 0.05% and 5% by weight of the polymeric composition. The amount added will depend upon the desired finished product, in particular, the amount of product aeration.

Water and glycerin are added to the polymeric composition as part of a plasticizing slurry. The plasticizing slurry is added to the dry blend before or after the addition of the leavening agent. The dry blend, slurry, and leavening agent form a polymeric composition prior to aeration. The slurry is added as a plasticizer and as a source of water to react with the chemical leavening agent to thereby cause the formation of CO₂ and, resultingly, the aerated construction. The slurry also provides moisture to the dry blend and leavening agent so that the polymeric composition will flow through the injection molding device without the addition of a reducing agent and without subjecting the composition to excessive heat or shear.

Dependent upon the desired characteristics of the end product, the amount of bicarbonate, or leavening agent, and slurry added will be varied. If a more aerated construction is desired, the amount of leavening agent will be increased. The slurry is important as an additive, because this hydrates the protein and allows elasticity of the protein.

It is preferred to pre-condition and injection mold the polymeric composition to form the desired end product. Once the shape of the injection-molded product has been formed, it is preferred to thermally set the polymeric composition to form the aerated polymeric pet chew. Thermal setting is desired because it causes the protein to denature, and thereby causes the individual protein strands to cross-link and associate with one another. This will cause the resultant product to have a unique structure and texture that is ductile, pliable, and somewhat elastic.

The resultant invention is advantageous for a variety of reasons. The aerated polymeric composition is desired because it has a pliable and compressible construction that is made from non-synthetic materials. The product is additionally advantageous because it is made of protein so that it will generally be considered more healthy than other compositions used to form similar products. Additionally, the product is biodegradable, and exhibits unique textural and functional attributes, which makes it desired for use in any of a variety of industries.

### BRIEF DESCRIPTION OF DRAWINGS

Attention is now directed to the drawings where like reference numerals and characters indicate corresponding or like components. In the drawings:

FIG. 1 is a perspective view of an exemplary article in accordance with an embodiment of the invention; and,

FIG. 2 is a cross sectional view of the article of FIG. 1 cut and folded rearward.

### DETAILED DESCRIPTION

The present invention relates to an aerated polymeric composition, methods for forming the aerated polymeric composition, and compositions for use in forming the aerated polymeric composition. In particular, the method relates to using a leavening agent or method to aerate a protein polymer, preferably a plant protein polymer without starch. The method further includes pre-conditioning, injection-molding, and denaturing a polymeric product. The present invention further relates to methods of using plant protein polymers to form the aerated polymeric composition. The resulting aerated polymeric composition is preferably used as a pet or animal chew. The resulting aerated polymeric composition may also be used as a biodegradable packing material. The present invention, in particular, relates to a pliable and flexible dog and cat chew, whereby the chew has an aerated construction, forming a porous structure. Preferably, the chew is formed from plant protein polymers, such as wheat gluten or soy protein, which produce edible and digestible chews having unique characteristics. Additionally, the present invention relates to methods of making the chew and methods for using plant protein polymer with a leavening agent.

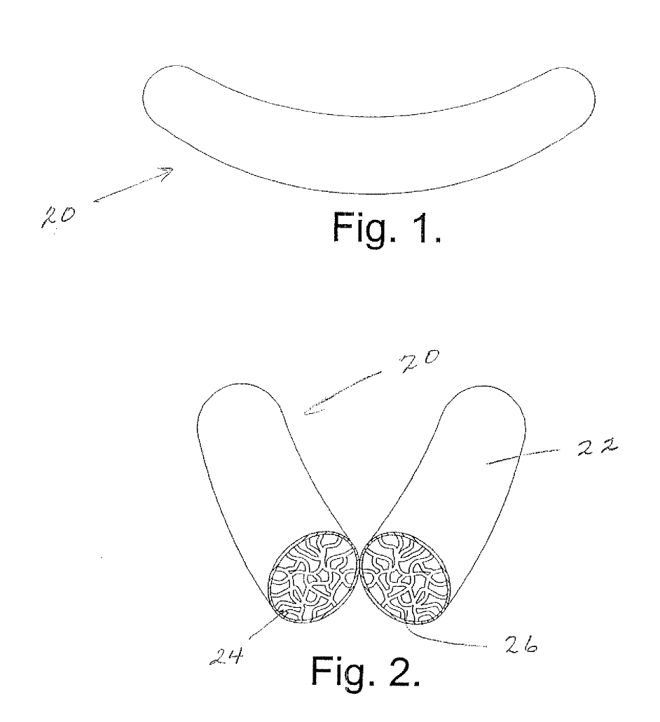

The preferred shape of the pet chew is shown in FIGS. 1 and 2. The Figs. show an article 20, that is, for example, shaped like a round stick, in accordance with an embodiment of the invention. Other shapes include bones, sticks, and bites. The article 20 has a smooth outer surface 22, substantially free of indentations or protrusions. This product, in the alternative can be wrinkled to some degree on the outside. In fact, in certain constructions, it is desired to have some degree of wrinkling. The inner portion 24 of the article is formed of air cells or caverns 26, resulting from aeration. The size of those caverns may vary, depending on the desired texture and use. This inner portion 24 provides the article 20 with a spongy texture, making it compressible, flexible and accordingly, pliable for the jaws (teeth and gums) of a typical dog or cat. The resultant product has memory, so that when compressed, it returns to its original shape once force is removed. As such, the resulting product, when applied to pets, provides chewing satisfaction for a pet, but can be consumed and swallowed in a comparatively shorter period of time, depending on the formulation and the size and distribution of the air cells.

The resultant pet chew has a body that includes a substantially sealed, non-porous, outer skin. The inner portion of the pet chew is integral with the skin. The inner portion has a porous construction and is substantially surrounded by the skin. The inner portion includes a plurality of cavities or air pockets to provide the body with elastic deformability and flexibility. The pet chew preferably has a body with a length ranging between 1 inch and 10 inches, and a diameter ranging between 0.125 inches and 5 inches.

Additionally, the chew has a pliability equal to being bent in half, without breaking. The shape of the chew will include a variety of shapes including a simple round stick, which has a porous interior with cavities ranging between 0.0005 inches and 0.040 inches in diameter. Conversely, the chew can be a hollow tube; the cavity size remains the same, however. Thus, the pet chew product can be of a variety of shapes, lengths, and diameters. The shape and size selected will depend upon the animal intended to consume the product. The age and size of the animal will also influence the finished product. Animals which are intended to consume the product include, but are not limited to, dogs, cats, birds, and small animals, such as hamsters, gerbils, chinchillas, ferrets, rats, and mice. Forming methods have been demonstrated through injection molding.

The method for forming the aerated polymeric composition, especially the pet chew, is dependent on the desired shape and the resultant aerated properties. The method is initiated by selecting a polymer for use in the product. The selected polymer and resulting polymeric mixture formulation should be such that gas trapping and rheological properties are provided to produce the unique textures and functionalities of the resultant pet chew product. Additionally, the flow properties of the selected polymer should allow for processing through injection molding equipment.

A polymeric composition is used to form an aerated polymeric pet chew. The polymeric composition includes an amount of a dry blend composition, a plasticizing slurry mixture, and a leavening agent. Once the polymeric composition is pre-conditioned and injection molded, and cured, or thermally set, it forms the aerated polymeric pet chew. The polymeric composition includes any of a variety of polymers that can optionally serve as a carrier of other materials, and can be flavored.

The dry blend includes an amount of a protein polymer equal to from about 5% to about 85% by weight of the dry blend. Any polymer, which can be aerated, consumed, and shaped into a desired structure, may be used. Preferably, the protein polymer is a plant protein; however, other proteins with the above-mentioned characteristics may be used alone or in combination with the plant protein. More preferably, an amount of plant protein equal to between about 30% and about 70% by weight of the aerated polymeric composition is included. Preferably, the plant protein is a gluten composition. The definition of gluten is a tenacious elastic protein substance, and includes, but is not limited to proteins such as gliadin, glutenin, globulin, and albumin. The gluten, when denatured, can form disulfide cross-links and hydrogen bonding between the proteins or their constituent amino acids. Wheat gluten is the most preferred gluten composition for use; however, soy protein, gelatin, corn gluten, and mixtures thereof may also be used.

It is desired for the plant protein to be treated so as to remove an amount of starch. In particular, the starch should be substantially removed, so that it is equal to or less than 15% by weight of the plant protein polymer. Alternatively, the starch should be substantially removed, so that it is equal to or less than 10% by weight of the plant protein polymer. Also, if necessary animal protein can be used herewith to adjust the texture and strength of the chew product.

The selected plant protein or protein polymer is combined with other constituents to form the dry blend composition. Other constituents included in the dry blend composition include flavors, processing aids, leavening agent, and colors.

An alternative dry blend composition includes a wheat gluten that has an element of starch remaining where it has not been purified. Additives that can be used with this gluten include cellulose and animal protein.

Flavors, for example, beef, chicken, fish, or other flavors, attractive to the senses of dogs and cats, can be added to the formulation. Any of a variety of flavors can be used to impart taste characteristics to the finished product. Flavors, typically meat (chicken, beef, pork, etc.), fruit and the like, can be added to the mixture before entering into the shaping process or during the shaping process. For example, beef flavoring may be added by placing beef broth, beef stock, or concentrated flavors into the dry blend while mixing or directly into the extruder barrel. Also, compositions such as liquid smoke, for example Charsol C-10 can be added as flavoring. The flavors are added according to taste.

Colors may also be added to the aerated polymeric composition at any time before or during the shaping process. These colors can include for example, Carmel coloring, Red (for example Red #40), Yellow (for example, Yellow #5 Lake), and the like. The amount added is dependent upon the finished color.

The method for forming the polymeric composition includes mixing a slurry mixture with the dry blend composition. The slurry can include water, plasticizers, and processing aids. The formulation includes an amount of water necessary to promote polymer formation. The water moistens the protein allowing the material to develop into a continuous mass and flow through the injection molding device. An amount of water, up to 30% by weight of the polymeric composition, more preferably up to 25% by weight of the polymeric composition and, most preferably, from about 10% to about 20% by weight of the polymeric composition may be included. The water, as detailed above, acts in combination with a humectant as a plasticizer, to hydrate the protein to make it a flowable continuous mass, and reacts with a leavening agent to form the gas for aeration of the polymer. A higher amount of water will cause the polymeric composition to become too sticky, unmanageable, and not flow through the injection molding device. If the high water content polymeric composition does flow through the device, the temperature increase to the material in the injection molding screw caused by friction and shear would damage the protein within the material.

A humectant, or plasticizer, is used at a level equal to from about 5% to about 80% by weight in the plasticizing slurry and, more preferably, from about 35% to about 70% by weight of the plasticizing slurry. The plasticizer slows the absorption of water into the protein so that the polymeric composition is more manageable and aids processability through an injection molding process. The preferred class of humectants include those selected from the group consisting of glycerol, propylene glycol, triethylene glycol, urea, sorbitol, mannitol, maltitol, hydrogenated corn syrup, polyvinyl alcohol, polyethylene glycol, C₁₂-C₂₂ fatty acids, and metal salts of such fatty acids, and mixtures thereof. The most preferred plasticizer is glycerol or glycerin. The formulations of this invention also include processing aids, cellulose, flavors, and colors.

An amount of a leavening agent is mixed with the dry blend and slurry mixture to form a polymeric composition. The leavening agent can be added to the dry blend prior to the addition of the slurry, or can be added after the addition of the slurry. Aeration, that forms the caverns 26, or a plurality of gas bubbles, in the article 20, typically occurs as a result of adding a leavening agent, such as bicarbonate, to the polymeric composition.

Leavening agents, such as sodium bicarbonate, react with water in the plasticizing slurry in the blending process and through the forming process, forming a gas that aerates the polymeric composition. Any of a variety of leavening materials can be used, including sodium bicarbonate and blends of bicarbonate with compounds such as sodium acid pyrophosphate, ammonium phosphate, monocalcium phosphate, sodium aluminum phosphate, as well as any of a variety of carbonates and other leavening agents. Leavening agents are defined as any chemical agent that generates a gas that would aerate the polymer. Chemical leavening agents from the following chemical families, which produce a gas when reacted under heat and/or in the presence of water, can be used: carbonates, bicarbonates, phosphates, or other chemical additives used separately, or in combination. Also, injection of a compressed gas into the flowable mixture within the injection molding screw can produce the same effect. Gaseous CO₂ can be added to the polymeric composition for this aeration step. It is preferred to use chemical leavening agents to form the aerated structure. It is more preferred to use sodium bicarbonate or baking powder. As such, any of a variety of compositions and methods can be practiced to promote aeration. The chemical leavening agent is added in a variety of amounts. Preferably, the chemical leavening agent is added in an amount ranging between 0.05% and 5.0% by weight of the polymeric composition. More preferably, the chemical leavening agent is added in an amount ranging between 0.25% and 2.5% by weight of the polymeric composition. As such, aeration occurs after forming the homogeneous, flowable mixture.

The polymeric composition is formed into desired shapes using injection molding. It is preferred that the polymeric composition not be subjected to excessive heat or shearing during the process. Excessive heat or shearing will denature the protein contained in the formulation reducing the ability of the protein to entrap the air or gas produced and as a result the amount of aeration within the product. To prevent excessive heat or shearing during the injection molding process it is desired that the polymeric composition be flowable in the injection molding device. The flowable polymeric composition is made by pre-conditioning, or moistening, the dry blend prior to transferring it into the injection molding device.

Pre-conditioning the dry blend includes mixing the dry blend, at least a portion of the plasticizing slurry, from about 50% to about 70% by weight of the total plasticizing slurry, and the leavening agent in a pre-conditioner, or mixing vessel, at room temperature, to form a polymeric mixture. The mixture is then transferred or released into an injection molding device to form the polymeric composition. The remaining portion of the plasticizing slurry, from about 30% to about 50% by weight of the total plasticizing slurry, is added directly to the injection molding device. The remaining portion of the plasticizing slurry may be added at the inlet to the screw of the injection molding device or it may be added into the barrel of the injection molding device from about 1 to 6 inches past the inlet. The rotational speed of the screw in the injection molding device is controlled such that the temperature increase to the material in the injection molding screw caused by friction and shear, are minimized so as to not denature the protein within the aerated polymeric composition. The formed composition is then injected into a mold, formed to shape, and heat cured. It is desired that the shot size, fed to the injection molding device, be proportional to the volume density of the desired shaped product. Typically, the shot size is defined by the volume or shape of the mold to be filled. If the shot size were equal to or greater than the volume of the mold, in this case, any aeration would be compressed out of the polymeric composition. As such, in the present invention, it is desirable that the injection shot size be less than that necessary to fill the mold so that the chemical leavening agent can expand the product to fill the mold. Leavening will be initiated at the tip of the injection molding screw and could continue to the completion of the heat curing step following the injection and filling of the mold. The polymeric composition is thermally set by curing at a temperature ranging between 80° C. and 145° C. to form an aerated polymeric composition or aerated polymeric pet chew. Advantageously, no further steps are required. Once the polymeric material of the aerated polymeric composition is denatured and fixed, in the curing step, any residual leavening action will not change the shape of the pet chew. The aerated polymeric composition, or aerated polymeric pet chew, has a compressible memory, such that when compressed, it has a desire to go back to its original shape once force is removed.

Formulations of the inventions also include agents, such as cellulose, emulsifiers, and other processing aids. Any of a variety of additives may be included. The additives can be used to further modify the texture, inhibit mold to preserve the product, or to provide nutritional or health benefits. For example, if the aerated polymeric composition is used as a biodegradable packing material, it may be desired to include stabilizing agents that discourage rodent activity within the composition. Suitable stabilizing agents include boric acid, pesticidal compounds, such as pyrethroids, among others.

The invention will now be described by way of Examples.

### EXAMPLES

### Example 1

Aerated Chews Injection Molding

The present Example was conducted to develop a formula that can be blended at the time of injection molding, placed into the injection molding device as a blend, and directly injection-molded into an aerated pet chew. Listed below are tests related to injection molding a pet treat. The wheat gluten used for these tests was a highly purified wheat gluten with starch removed.

| | Test 1 | Test 2 | Test 3 | Test 4 | Test 5 |
|---|---|---|---|---|---|
| Chew Bone Regrind | 1.5 | 1.5 | 0 | 0 | 0 |
| Wheat Gluten | 5.3 | 5.3 | 5.3 | 5.3 | 5.3 |
| Cellulose | 0.2 | 0.2 | 0.2 | 0.2 | 0.2 |
| Glycerol Monostearate | 0.3 | 0.3 | 0.3 | 0.3 | 0.3 |
| Baking powder | 0.0373 | 0 | 0 | 0 | 0 |
| Sodium Bicarbonate | 0 | 0.0373 | 0.0373 | 0.025 | 0.025 |
| Gelatin | 0.5 | 0.5 | 0.5 | 0.5 | 0.25 |
| Digest Flavor | 0 | 0 | 0.35 | 0.35 | 0.35 |
| Glycerin | 2.1 | 2.25 | 2.25 | 2.25 | 2.25 |
| Water | 0.577 | 1.5 | 1.5 | 1.5 | 1.5 |
| Total (lbs.) | 10.5143 | 11.5873 | 10.4373 | 10.425 | 10.175 |
| | Test 6 | Test 7 | Test 8 | Test 9 | Test 10 |
| Wheat Gluten | 5.3 | 5.3 | 5.3 | 5.3 | 5.3 |
| Cellulose | 0.2 | 0.2 | 0.2 | 0.2 | 0.2 |
| Glycerol Monostearate | 0.3 | 0.3 | 0.3 | 0.3 | 0.3 |
| Baking powder | 0 | 0.0373 | 0 | 0 | 0 |
| (Fast Acting) | | | | | |
| Baking powder | 0 | 0 | 0.0373 | 0 | 0 |
| (Slow Acting) | | | | | |
| Sodium Bicarbonate | 0.025 | 0 | 0 | 0.025 | 0.025 |
| Gelatin | 1.0 | | | | |
| Rice Meal | 0 | 0 | 0 | 1.5 | 0 |
| Cat Nip powder | 0 | 0 | 0 | 0 | 0.15 |
| Digest Flavor | 0.35 | 0.35 | 0.35 | 0.35 | 0 |
| Glycerin | 2.25 | 2.25 | 2.25 | 2.25 | 2.25 |
| Water | 1.5 | 1.5 | 1.5 | 1.5 | 1.5 |
| Total (lbs.) | 10.925 | 10.4 | 10.4 | 11.925 | 10.225 |

The injection molding device was a Cincinnati Milacron 500 Ton Vista Hydraulic Injection Molding Machine. The machine setup was as follows:

Clamp

| | | | |
|---|---|---|---|
| Close Speed 1 | 18.50 in/s | Breakaway Speed | 0.50 in/s |
| Slowdown | 8.50 in | Open Fast | 8.00 In |
| Mold Protect Pressure | 500 psi | Open Fast Speed | 18.00 in/s |
| Mold Protect Timer | 10.000 sec | Open Slowdown | 29.00 In |
| Mold Touch | 7.51 in | Open Limit | 35.00 In |
| Tonnage | 250 tons | | |

Ejector

| | | | |
|---|---|---|---|
| Fwd Spd 1 | 0.50 in/s | Ret Speed | 4.50 in/s |
| Fwd Pos 2 | 0.00 in | Pulse Retract | 0.00 in |
| Fwd Spd 2 | 2.00 in/s | Ret Limit | 2.48 in |
| Fwd Limit | 3.50 in | Pulse(s) | 2 |
| Dwell | 0.000 sec | Start Eject | 14.00 in |
| | | Ret Override | 0.00 in |

Temperatures

| | | | |
|---|---|---|---|
| Nozzle | 140° F. | Zone 1 | 135° F. |
| | | Zone 2 | 130° F. |
| | | Zone 3 | 130° F. |
| Alarm Band | 20% | | |
| Feedthroat | 65° F. | | |

Timers

| | | | |
|---|---|---|---|
| Cycle Alarm Limit | 115.000 sec | Cooling/Heating | 95.000 sec |
| Inject High | 15.000 sec | Extruder Delay | 0.000 sec |
| Pack | 4.000 sec | Sled Retract | 0.750 sec |
| Hold | 2.000 sec | Open Dwell | 0.000 sec |

Injector Control Data

| | | |
|---|---|---|
| Shot Size | 6.25 in | Off |
| Switchpoint 1 | 75% | 50% |
| Switchpoint 2 | 55% | 0.00 in |
| Switchpoint 3 | 35% | 0.95 in/s |
| Switchpoint 4 | 20% | 0.80 in/s |
| Position Xfer | 0.08 in | 0.70 in/s |
| Hydraulic Xfer | 0 psi | 0.60 in/s |
| Fill Press Limit | 1900 psi | 0.20 in/s |
| Pack 1 | 1800 psi | 1800 in/s |

Extruder Control Data

| | | | |
|---|---|---|---|
| RPM 1 | 53% | Back Pres 1 | 30 psi |
| Dec Before | 0.00 in | Dec After | 0.00 in |

Air Eject

| | | | |
|---|---|---|---|
| Air Eect 1 | Off | Position | 37.00 in |
| Delay | 0.000 sec | Blast | 10.000 sec |
| Air Eject 2 | Off | Position | 0.00 in |
| Delay | 0.000 sec | Blast | 5.000 sec |

Cores

| | | | |
|---|---|---|---|
| Core 1 Set Selection | 0 | Core 1 Set Position | 9.40 in |
| Core 1 Pull Selection | 0 | Core 1 Pull Selection | 9.40 in |

Standard Options

Auto Heat Start

| | | | |
|---|---|---|---|
| Day of Week | 3 | Nozzle Temp | 425° F. |
| Hour of Day | 20 | | |
| Minute of Hour | 19 | Barrel Temp | 425° F. |

Auto Shut Down

| | | | |
|---|---|---|---|
| Cavities | 1 | Nozzle Temp | 425° F. |
| Shut Down Delay | 1 min | | |
| Total Parts Needed | 1 | Barrel Temp | 425° F. |
| | | Stand-by Heat | Off |

Purge Cycles

| | | | |
|---|---|---|---|
| Number of Purge Cycles | 3 | Backpressure Setpoint | 150 psi |
| Ext Speed | 85% | Allow Time | 10 sec |

The resultant injection-molded chews were of a desirable construction exhibiting a ductile and compressible aerated structure. The chews had a compressible memory, such that when compressed, they go back to their original shape, once force is removed.

### Example 2

The present Example relates to development of a formula that can be blended on site, placed into the injection molding machines, and directly injection-molded into an aerated pet chew. The run conditions were the same as Example 1.

| | Test 1 | Test 2 | Test 3 | Test 4 |
|---|---|---|---|---|
| Soy Protein Isolate | 0 | 5.3 | 0 | 0 |
| Soy Protein Concentrate | 0 | 0 | 5.3 | 0 |
| Hydrolyzed Gelatin | 0 | 0 | 0 | 4.8 |
| Wheat Gluten | 5.3 | 2.0 | 2.0 | 2.0 |
| Cellulose Powder | 0.2 | 0.2 | 0.2 | 0.2 |
| Magnesium Stearate | 0 | 0 | 0 | 0 |
| Glycerol Monostearate | 0.3 | 0.3 | 0.3 | 0.3 |
| Baking Powder (Slow Acting) | 0 | .0373 | .0373 | .0373 |
| Sodium Bicarbonate | 0.025 | 0 | 0 | 0 |
| Gelatin (Technical Grade) | 0.5 | 0.5 | 0.5 | 1.0 |
| Cat Nip Powder | 0.15 | 0 | 0 | 0 |
| Digest Flavor (Mondovi) | 0 | 0.4 | 0.4 | 0.4 |
| Glycerin | 2.25 | 2.3 | 2.3 | 2.3 |
| Water | 1.5 | 3.0 | 3.0 | 1.5 |
| Total (lbs.) | 10.225 | 13.9 | 13.9 | 12.4 |

A suitable product was produced exhibiting a ductile and compressible aerated structure. The chews had a compressible memory, such that when compressed, they go back to their original shape, once force is removed.

Thus, there has been shown and described an aerated polymeric composition which fulfills all the objects and advantages sought therefor. It is apparent to those skilled in the art, however, that many changes, variations, modifications, and other uses and applications to the aerated polymeric composition are possible, and also such changes, variations, modifications, and other uses and applications which do not depart from the spirit and scope of the invention are deemed to be covered by the invention, which is limited only by the claims which follow.

What is claimed is:

1. A method for forming an aerated polymeric composition, comprising:
(a) forming a dry blend, having a protein polymer with an amount of starch removed, wherein the amount of starch remaining is equal to less than 10% by weight of the protein polymer, the dry blend further comprising a flavor;
(b) adding a leavening agent to the dry blend;
(c) adding a plasticizing slurry mixture to the dry blend and leavening agent to form a polymeric mixture, wherein the plasticizing slurry mixture comprises water and a humectant selected from the group consisting of sucrose, fructose, glucose, glycerin, propylene glycol, dextrose, xylotol, corn syrup, high fructose corn syrup, maltose, hydrogenated starch hydolysate, and combinations thereof;
(d) processing and curing the polymeric mixture in an injection molding device to activate a reaction between the plasticizing slurry and the leavening agent to produce a gas and form an aerated polymeric composition, wherein the pet chew has a porous interior with cavities ranging between 0.0005 inches and 0.040 inches in diameter.

2. The method of claim 1, wherein the dry blend composition comprises a polymer free of starch.

3. The method of claim 1, wherein the leavening agent is selected from the group consisting of sodium bicarbonate, and sodium bicarbonate in combination with sodium acid pyrophosphate, ammonium phosphate, monocalcium phosphate, and sodium aluminum phosphate.

4. The method of claim 1, wherein the dry blend comprises a wheat gluten.

5. The method of claim 1, wherein the dry blend comprises plant protein equal to between 20% and 95% by weight of the aerated polymeric composition.

6. The method of claim 1, wherein the dry blend composition comprises a protein polymer, processing aids, cellulose, and colors.

7. The method of claim 1, wherein the leavening agent is added in an amount ranging between 0.05% and 5% by weight of the dry blend.

8. The method of claim 1, wherein the plasticizing slurry comprises an amount of water ranging between 5% and 60% by weight of the plasticizing slurry.

9. The method of claim 1, wherein the plasticizing slurry comprises humectant equal to between 20% and 70% by weight of the plasticizing slurry.

10. The method of claim 1, wherein the curing step comprises subjecting the aerated polymeric composition to a temperature ranging between 80° C. and 148° C. to denature and fix the polymeric composition.

11. An aerated polymeric composition having a porous interior with cavities ranging between 0.0005 inches and 0.040 inches in diameter, the composition comprising:
(a) a dry blend composition, having a protein polymer with an amount of starch equal to less than 10% by weight, the dry blend further comprising a flavor;
(b) a plasticizing slurry mixture, the plasticizing slurry mixture comprising water and a humectant selected from the group consisting of sucrose, fructose, glucose, glycerin, propylene glycol, dextrose, xylotol, corn syrup, high fructose corn syrup, maltose, hydrogenated starch hydolysate, and combinations thereof; and,
(c) a leavening agent.

12. The composition of claim 11, wherein the dry blend comprises a protein selected from the group consisting of an animal protein, a plant protein polymer, a plant protein polymer having starch removed, and combinations thereof.

13. The composition of claim 11, wherein the plasticizing slurry comprises an amount of water ranging between 2% and 25% by weight of the composition.

14. The composition of claim 11, wherein the dry blend comprises an amount of vegetable protein equal to between 20% and 95% by weight of the dry blend composition.

15. The composition of claim 11, wherein the plasticizing slurry comprises glycerin and water.

16. The composition of claim 11, wherein the plasticizing slurry comprises an amount of water ranging between 5% and 60% by weight of the plasticizing slurry.

17. The composition of claim 11, wherein the leavening agent is selected from the group consisting of sodium bicarbonate, and sodium bicarbonate in combination with sodium acid pyrophosphate, ammonium phosphate, monocalcium phosphate, and sodium aluminum phosphate.

18. The composition of claim 11, wherein the leavening agent is selected from the group consisting of CO₂ and nitrogen.

19. The composition of claim 11, wherein the aerated polymeric composition is an aerated polymeric pet chew.

20. The composition of claim 11, wherein the aerated polymeric composition is a biodegradable packing material.

21. The composition of claim 20, further comprising stabilizing agents that discourage rodent activity.

22. A method for forming an aerated polymeric pet chew, comprising:
(a) forming a dry blend, having a protein polymer with an amount of starch removed, wherein the amount of starch remaining is equal to less than 10% by weight of the protein polymer, the dry blend further comprising a flavor;
(b) adding a leavening agent to the dry blend;
(c) adding a plasticizing slurry mixture to the dry blend and leavening agent to form a polymeric mixture, wherein the plasticizing slurry mixture comprises water and a humectant selected from the group consisting of sucrose, fructose, glucose, glycerin, propylene glycol, dextrose, xylotol, corn syrup, high fructose corn syrup, maltose, hydrogenated starch hydolysate, and combinations thereof;
(d) processing and curing the polymeric mixture in an injection molding device to activate a reaction between the plasticizing slurry and the leavening agent to produce a gas and form an aerated polymeric composition, wherein the pet chew has a porous interior with cavities ranging between 0.0005 inches and 0.040 inches in diameter and wherein curing the aerated polymeric composition comprises subjecting the aerated polymeric composition to a temperature between 80° C. and 148° C. to denature and fix the polymeric composition.

23. The method of claim 22, wherein the leavening agent is selected from the group consisting of sodium bicarbonate, and sodium bicarbonate in combination with sodium acid pyrophosphate, ammonium phosphate, monocalcium phosphate, and sodium aluminum phosphate.

24. The method of claim 22, wherein the leavening agent is selected from the group consisting of CO₂ and nitrogen.
